(19) United States
(12) Patent Application Publication
(10) Pub. No.: US 2025/0126189 A1
(43) Pub. Date: Apr. 17, 2025

(54) PACKET LOAD BALANCER

(71) Applicant: Intel Corporation, Santa Clara, CA (US)

(72) Inventors: Ping YU, Shanghai (CN); Hongjun NI, Shanghai (CN); Tao ZHU, Chengdu (CN); Houxiang CAI, Chengdu (CN); Wenjian SHAO, Shanghai (CN)

(21) Appl. No.: 18/986,566

(22) Filed: Dec. 18, 2024

(30) Foreign Application Priority Data
Nov. 21, 2024 (WO) PCT/CN2024/133437

(51) Int. Cl. H04L 69/22; H04L 67/1004

(52) U.S. Cl. CPC H04L 69/22; H04L 67/1004

(57) ABSTRACT

Examples described herein relate to processing packets. In some examples, based on receipt of a Hypertext Transfer Protocol (HTTP) packet at a network interface device, the HTTP packet comprising an HTTP body and HTTP header: provide the HTTP header, but not the HTTP body, for processing in user space; modify solely the HTTP header in user space; and in kernel space, combine the modified HTTP header and the HTTP body prior to transmission of the HTTP packet with modified HTTP header to a client.

### CLAIM OF PRIORITY

This application claims the benefit of priority to Patent Cooperation Treaty (PCT) Application Number PCT/CN2024/133437, filed Nov. 21, 2024. The entire contents of that application are incorporated by reference.

### BACKGROUND

The Internet provides communications between client devices (clients) and servers. For example, clients can request access to web pages or services that are hosted and served by the servers. A load balancer is a service that acts as a reverse proxy and distributes network or application traffic across multiple servers. Load balancers are used to increase a number of concurrent users and reliability of client-executed applications connectivity with the servers. Load balancers can improve availability and performance of online services.

### BRIEF DESCRIPTION OF THE DRAWINGS

FIG. 1 depicts an example system.

FIG. 2 illustrates an example of operations.

FIG. 3 illustrates an example of operations.

FIG. 4 illustrates an example of operations.

FIG. 5 depicts an example system.

FIG. 6 depicts an example of operations.

FIGS. 7A and 7B depict example processes.

FIG. 8 depicts an example network interface device.

FIG. 9 depicts an example system.

### DETAILED DESCRIPTION

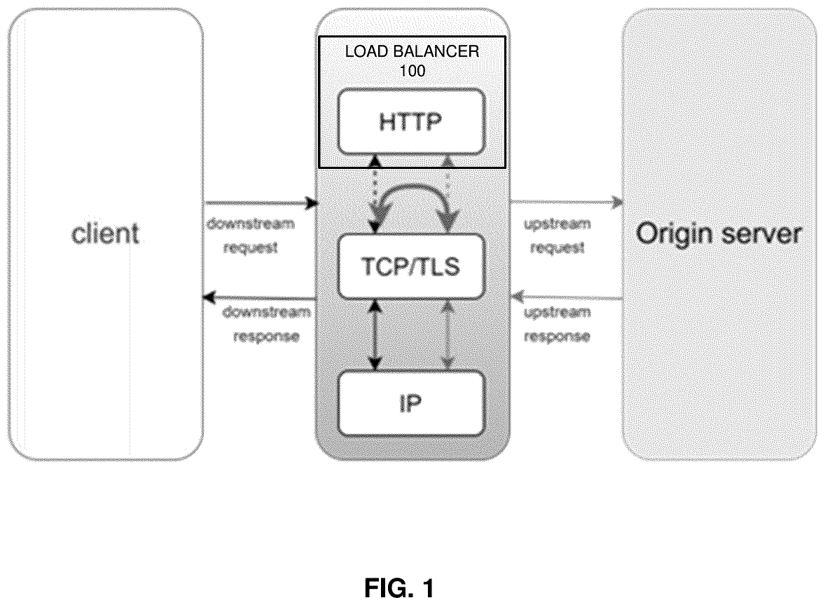

FIG. 1 depicts an example system. Various examples described herein can be used by the system of FIG. 1. Hypertext Transfer Protocol (HTTP) is a request and response mechanism that enables the exchange of information between clients (e.g., web browsers or applications) and servers. For example, as initiated by the client, an HTTP request is made when a user enters a Uniform Resource Locator (URL) in a browser or clicks on a hyperlink. This request can include a request line (e.g., GET or POST, the resource URL, and the HTTP version), headers (e.g., information about the request or client), and a body (e.g., data to be sent to the server, such as in POST requests). The server can respond with an HTTP response, which includes a status line (e.g., HTTP version, a status code indicating the result of the request, and a status message), response headers (e.g., information about the server or data being sent), and a body (e.g., requested resource or data). This request-response cycle can allow for dynamic delivery of content and interactive web experiences. Examples of HTTP protocols include at least: Network Working Group Request for Comments (RFC) 1945 (May 1996), RFC 9110 (June 2022), RFC 9111 (June 2022), RFC 9112 (June 2022), RFC 9113 (June 2022), as well as variations and derivatives thereof.

An application level load balancer 100 can forward requests from the client to the server and responses from the server to the client. Load balancer 100 can apply to HTTP requests or responses. A response message can include a status line, header, and body. A header can provide metadata about the response or the server. Headers can include content that are key-value pairs, and common headers include Content-Type, Content-Length, and Set-Cookie. Load balancer 100 can modify fields in the header after receiving the fields from the origin server before sending to clients. The body of the response can include data sent to the client, such as Hypertext Markup Language (HTML) content, binary data (e.g., images or files), JSON data for APIs, and so forth.

In load balancer 100, traffic received at the network interface device can be processed based on Internet Protocol (IP) and Transmission Control Protocol (TCP)/Transport Layer Security (TLS) protocols and the HTTP protocol, and then copied through the TCP and IP protocol processing stacks before being transmitted by the network interface device to the client or server. Routing of traffic from IP and TCP/Transport Layer Security (TLS) layers to the HTTP layer and back to IP and TCP/TLS protocol processing can decrease performance as data copy operations may introduce latency. Various examples can bypass HTTP protocol processing of HTTP request or response packet bodies. For example, a control plane can cause a HTTP header processing process to redirect packet bodies to bypass HTTP protocol processing. Various examples can be performed by a host processor-executed software stack and/or network interface device.

In some examples, a redirector utilized in IP protocol processing and/or reliable data transmission protocol processing can direct control plane traffic for application processing, while routing HTTP payloads to bypass HTTP header processing. A redirector could be implemented in kernel space or an eBPF program to redirect traffic from one socket connection to another socket connection, and could be configured by a user space application with the parameters such as “source socket,” “destination socket,” “how many bytes to shortcut for a number of body bytes,” and so forth. The redirector can be called by an application such as a load balancer.

A packet may be used herein to refer to various formatted collections of bits that may be sent across a network, such as Ethernet frames, IP packets, TCP segments, UDP datagrams, etc. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

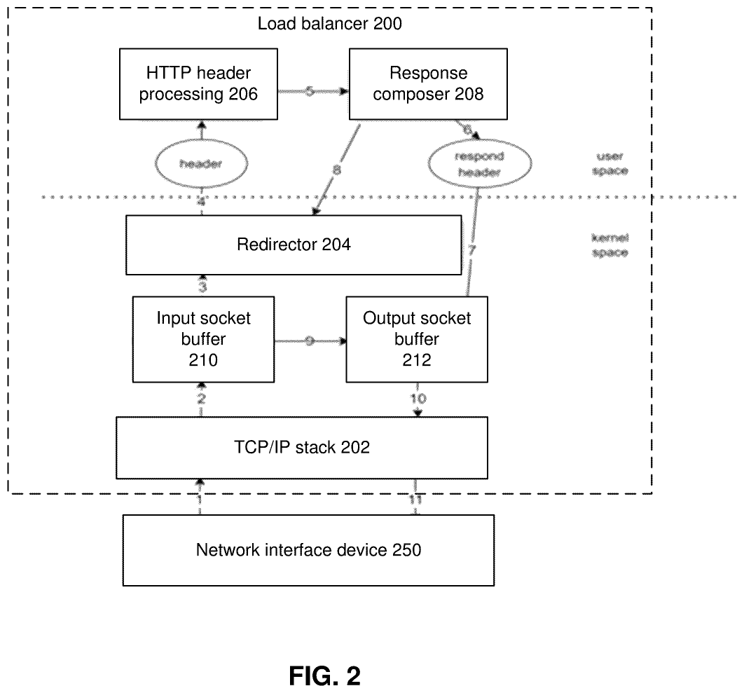

FIG. 2 illustrates an example of operations to process HTTP packets. A computing system can execute processes in kernel and user space to perform operations described herein. An example computing system can include processors, memory, and other circuitry or software, such as described with respect to FIGS. 1 and/or 9. For example, a processor-executed operating system (OS) can separate memory or virtual memory into kernel space and user space to provide memory protection and hardware protection from malicious or errant software behavior. User space can be memory allocated to running applications and some drivers. Processes running under user space may have access to a limited part of memory, whereas the kernel may have access to a larger region of the memory. Kernel space can be memory allocated to the kernel, kernel extensions, some device drivers and the operating system. A kernel can manage applications running in user space. Kernel space can be a location where the code of the kernel is stored and executes within.

In operations (1)-(3), network interface device 250 can receive an HTTP packet (e.g., response or request), and after processing by processor-executed TCP/IP protocol processing stack 202, provide the HTTP packet to processor-executed TCP redirector 204 by input socket buffer 210. The HTTP packet header can include the length of a response included in the HTTP packet body. In operation (4), at the beginning of a stream, TCP redirector 204 can pass part of socket buffer 210 to HTTP header processing 206 in user space. After TCP redirector 204 shortcuts a specified size for the length of the HTTP packet payload to outgoing socket buffer 212, new incoming traffic can be delivered to HTTP header processing 206 for another round of request/response processing.

In operations (5)-(7), in user space, HTTP header processing 206 of load balancer 200 can parser the packet header, and generate the response based on the origin server's header by adding or modifying some fields in the header. The modified response header can be delivered to outgoing socket buffer 212.

In operation (8), TCP redirector 204 can issue a command to start shortcut mode with parameters such as the source socket and the destination socket, and how many bytes of payload to fast forward or short cut. In operation (9), instead of HTTP body traffic being copied from kernel to user space, merely the HTTP header can be provided to user space, while the HTTP body can be stored in kernel space in output socket buffer 212. In some examples, TCP redirector 204 can be implemented as a socket option, FAST_FORWARDING, whereby load balancer 200 can call getsockopt to perform forwarding of HTTP header for HTTP header processing. In some examples, eBPF helper bpf_sk_redirect_map can perform redirection of HTTP header or HTTP response in kernel space.

In operations (10) to (11), HTTP header processing 206 can generate a response header from processed response header and attach the processed response header to the HTTP body. The resulting HTTP packet, stored in outgoing socket buffer 212, can be delivered to TCP/IP stack 202 for network interface device 250 to send to a client or server.

In some networking layer implementations, TLS encrypted record or data traffic can be transmitted in TCP packets. Some TLS transportation implementations can be implemented in user space, and applications can implement TLS transportation by accessing TLS/Secure Sockets Layer (SSL) libraries including OpenSSL, or others. Various examples can decrypt TLS records into plaintext HTTP packets and utilize a TCP redirector to direct HTTP headers and payloads of TLS encrypted traffic in a similar manner as described with respect to FIG. 2.

Although examples are described with respect to TCP, other reliable transport protocols can be used including: remote direct memory access (RDMA), User Datagram Protocol (UDP), quick UDP Internet Connections (QUIC), RDMA over Converged Ethernet (ROCE), RoCE v2, or others.

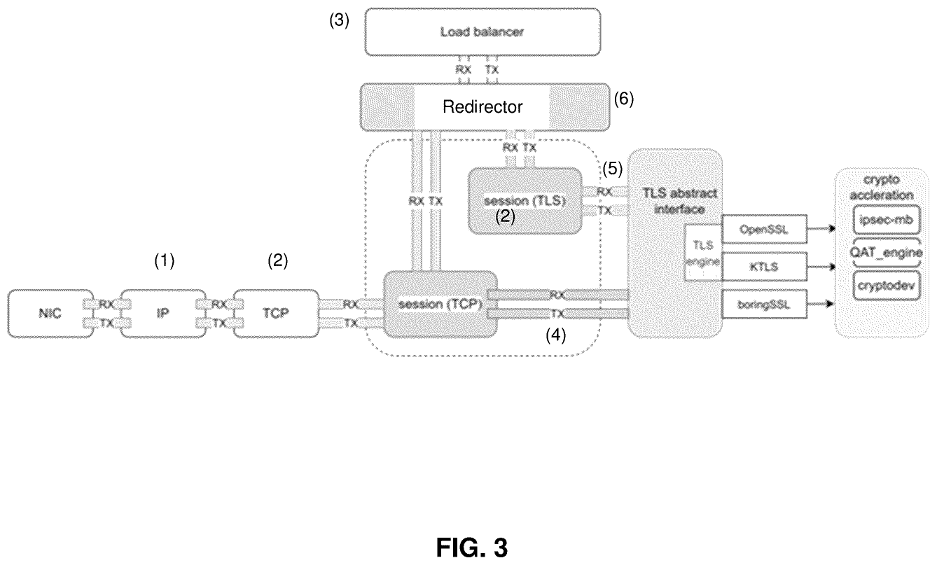

FIG. 3 illustrates an example of operations. When a packet is received from a network interface device (e.g., network interface controller (NIC)), the packet can be processed at (1) and (2) according to respective IP and TCP protocols. For a TCP session, at (3), the packet could be delivered to a processor-executed load balancer via director for processing and eventual transmission through the network interface device to another device. However, for a TLS flow, at (4), the packet can be directed to TLS abstract interface, which could call vendor specific TLS libraries such as OpenSSL, boringSSL or kernel TLS (KTLS), when in kernel space, to decrypt the packet (e.g., using a crypto accelerator) and deliver the packet to the TLS session. At (5), processor-executed TLS session protocol processing could communicate with director to pass or direct a decrypted HTTP header for HTTP header processing in user space, and combine the modified HTTP header with an HTTP payload in kernel space. The HTTP packet formed from the modified HTTP header and HTTP payload can be re-encrypted with TLS and transmitted by network interface device.

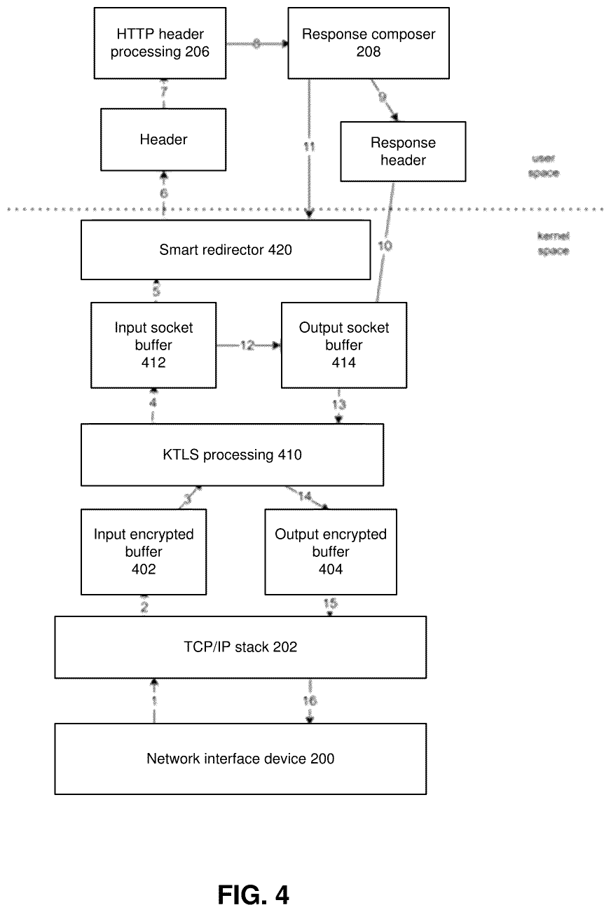

FIG. 4 illustrates an example of operations. Network interface device 250 can receive a packet and provide the packet, at (1), for processing by TCP/IP protocol processing stack 202. At (2), TCP and IP protocol processing can be performed on the received packet, which includes encrypted contents (e.g., HTTP packet), and contents of the received packet can be stored in buffer 402. At (3), in kernel space, KTLS processing 410 can be performed to process the session and decrypt the incoming encrypted buffer into plaintext, which is readable by redirector 420 and for HTTP protocol processing.

In operations (4)-(7), processor-executed redirector 420 can identify a start of an HTTP packet, and deliver the HTTP header to user space for HTTP header processing 206. In operations (8)-(10), HTTP header can be processed according to an HTTP protocol, and response composer 208 can generate a response header and deliver the response header to kernel space in plaintext mode to output socket buffer 414.

In operations (11)-(12), response composer 208 can command redirector 420 to provide a shortcut for the incoming “body_length” bytes, and incoming plaintext of an HTTP body can be redirected to outgoing socket buffer 414. In operations (13)-(16), HTTP packet traffic can be delivered to KTLS processing 410, and then encrypted with a downstream session key and sent to another network interface device.

Accordingly, HTTP packets encrypted with TLS can be split so that headers can be processed in user space but payloads are not provided to user space. Single TLS direction traffic can be supported, such as TLS for only downstream or upstream, and the other direction transmits packets in plaintext mode. While examples are described with respect to TLS (e.g., The Transport Layer Security (TLS) Protocol Version 1.3, RFC 8446 (August 2018)), other example encryption protocols can be used, such as: Datagram Transport Layer Security (DTLS). DTLS is defined at least by Network Working Group Request for Comments (RFC) 4347 (2006) and Internet Engineering Task Force (IETF) Datagram Transport Layer Security (DTLS) protocol Version 1.3 (2020), PSP Security Protocol (PSP), or others.

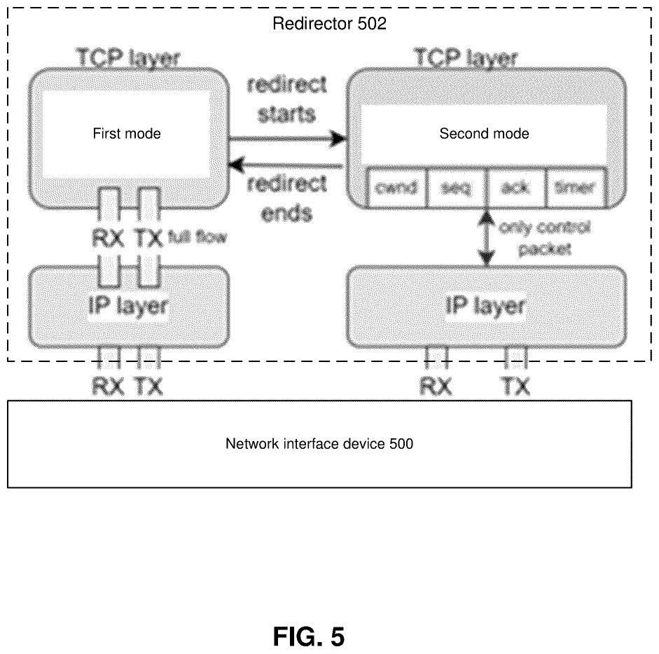

FIG. 5 depicts an example system. A processor-executed TCP/TLS redirector 502 can prevent a memory copy of HTTP packet payload from kernel space to user space and back to kernel space, but permit processing of the HTTP packets according to TCP/IP protocols. For example, based on identification of a destination socket, network interface device 500 can update the packet information in place by filling the N-tuples in the packet header, and then directly send the packet to a downstream device (e.g., client or server), saving TCP processing time without a copy of the HTTP payload to user space.

In a first mode, IP layer packets are delivered to TCP stack for processing and the TCP stack maintains TCP connection status by updating time wheel, maintain congestion windows, sequence number, etc. In a second mode, redirector 502 can update or track sequence number and ACK numbers of arriving packets but not provide packets for TCP processing, but provide session state updating packets (e.g., session ending state, such as RST, FIN, and so forth) can be delivered to TCP processing stack to terminate a session.

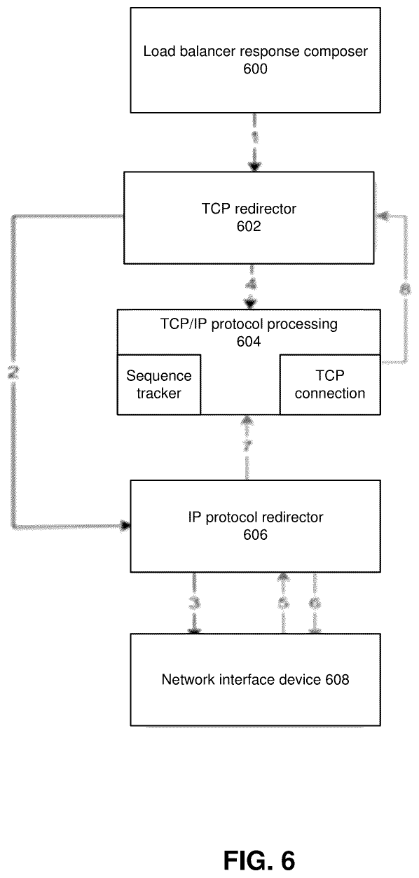

FIG. 6 depicts an example of operations of the system of FIG. 5. In operation (1), at a beginning of TCP connection, processor-executed load balancer response composer 600 can provide a plaintext socket buffer for HTTP header processing, and load balancer response composer 600 can perform a shortcut and deliver a command to processor-executed TCP redirector 604 to not provide HTTP payload for processing by processor-executed TCP/IP protocol processing 604. For example, TCP redirector 604 can provide the parameters [source socket, destination socket, bytes_to_forwarding] to indicate portions of an HTTP packet to not provide for TCP processing.

In operation (2), TCP redirector 602 can fetch both upstream and downstream TCP connection information, define the IP layer shortcut parameters, and instruct processor-executed IP protocol redirector 606 as to source socket n-tuples, destination socket n-tuples, end sequence ID for forwarding, end acknowledge number, or other state.

In operation (3), if network interface device 608 performs the shortcut mode, IP redirector 606 can send the shortcut parameters to network interface device 608. However, a processor other than network interface device 608 can perform operations of a shortcut mode.

In operation (4), during a shortcut stage, processor-executed TCP/IP protocol processing layer 604 may not receive packets from connections but TCP redirector 602 can update TCP/IP layer 604 with new sequence number and acknowledge number, such as at or after ending of a shortcut.

In operations (5) and (6), based on receipt of a packet at network interface device 608, IP redirector 606 can update the packet header with the downstream N-tuples, and then network interface device 608 can send the updated packet, including an ACK packet, to a next device. However, network interface device 608 can provide received packets that are to cause a tear down of the connection (e.g., FIN, RST) to TCP/IP layer 604 for processing. In operation (7), after completion of shortcut, based on receipt of an end sequence packet, received packets can be provided to TCP layer 604 for processing, and TCP redirector 602 can deliver the HTTP packet header for HTTP header processing in user space in a manner described herein at least with respect to FIG. 2.

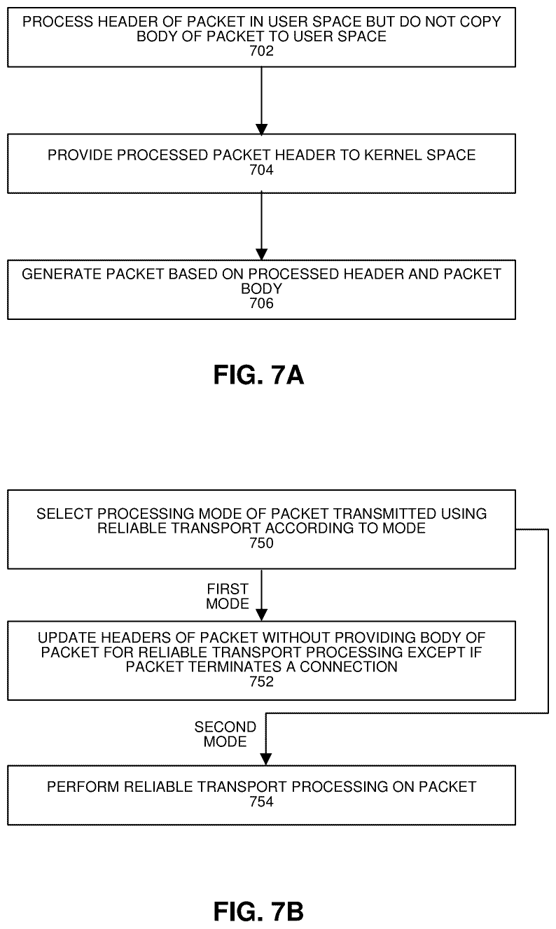

FIG. 7A depicts an example process. The process can be performed by a processor-executed process and/or a network interface device. At 702, based on receipt of an HTTP packet, the HTTP header can be provided to a user space for HTTP processing and the HTTP packet body can be retained in kernel space. In some examples, an encrypted HTTP packet can be decrypted into plaintext prior to processing and separation of HTTP header from HTTP body. Processing an HTTP header can generate an HTTP header with one or more modified header fields. At 704, processed HTTP header can be provided to a kernel layer for processing. At 706, a packet can be formed based on processed HTTP header and HTTP packet body. The packet can be transmitted to another device, such as a client or server.

FIG. 7B depicts an example process. The process can be performed by a processor-executed process and/or a network interface device. At 750, based on receipt of a packet that includes an HTTP packet, the packet can be processed according to a mode of operation. At 752, based on a first mode of operation, headers of the received packet can be updated without providing the received packet for reliable data transmission protocol processing. But based on the received packet including a connection termination packet, the received packet with connection termination packet can be provided for reliable data transmission protocol processing. At 754, based on a second mode of operation, the received packet can be provided for reliable data transmission protocol processing.

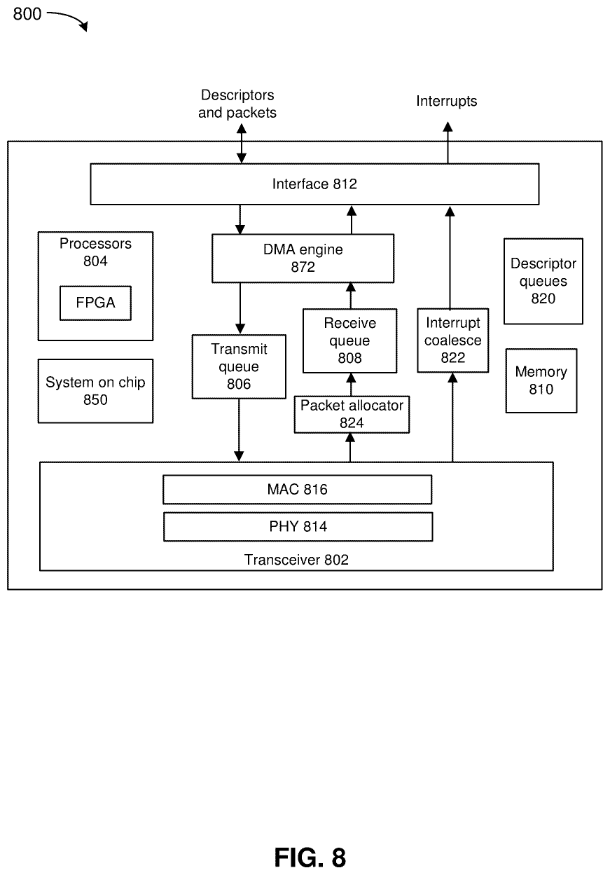

FIG. 8 depicts an example network interface device. In some examples, circuitry of network interface device can be utilized to perform packet header processing, bypass copying of the header payload to user space, and combine the processed header with the packet body, and/or update headers of a packet without providing the received packet for reliable data transmission protocol processing except for connection termination packet, as described herein. In some examples, packet processing device 800 can be implemented as a network interface controller, network interface card, a host fabric interface (HFI), or host bus adapter (HBA), and such examples can be interchangeable. Packet processing device 800 can be coupled to one or more servers using a bus, PCIe, CXL, or Double Data Rate (DDR). Packet processing device 800 may be embodied as part of a system-on-a-chip (SoC) that includes one or more processors, or included on a multichip package that also contains one or more processors.

Some examples of packet processing device 800 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values.

Processors 804 can be any a combination of a: processor, core, graphics processing unit (GPU), field programmable gate array (FPGA), application specific integrated circuit (ASIC), or other programmable hardware device that allow programming of network interface 800. For example, a “smart network interface” can provide packet processing capabilities in the network interface using processors 804.

Processors 804 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

As described herein, processors 804 can perform processing of HTTP headers in user space without copying HTTP payloads to user space and can form a packet with processed HTTP headers and HTTP payloads in kernel space, and/or update headers of a packet without providing the received packet for reliable data transmission protocol processing except for connection termination packet.

Configuration of operation of processors 804, including its data plane, can be programmed based on one or more of: Protocol-independent Packet Processors (P4), Software for Open Networking in the Cloud (SONIC), Broadcom® Network Programming Language (NPL), NVIDIA® CUDA®, NVIDIA® DOCA™, Infrastructure Programmer Development Kit (IPDK), among others.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

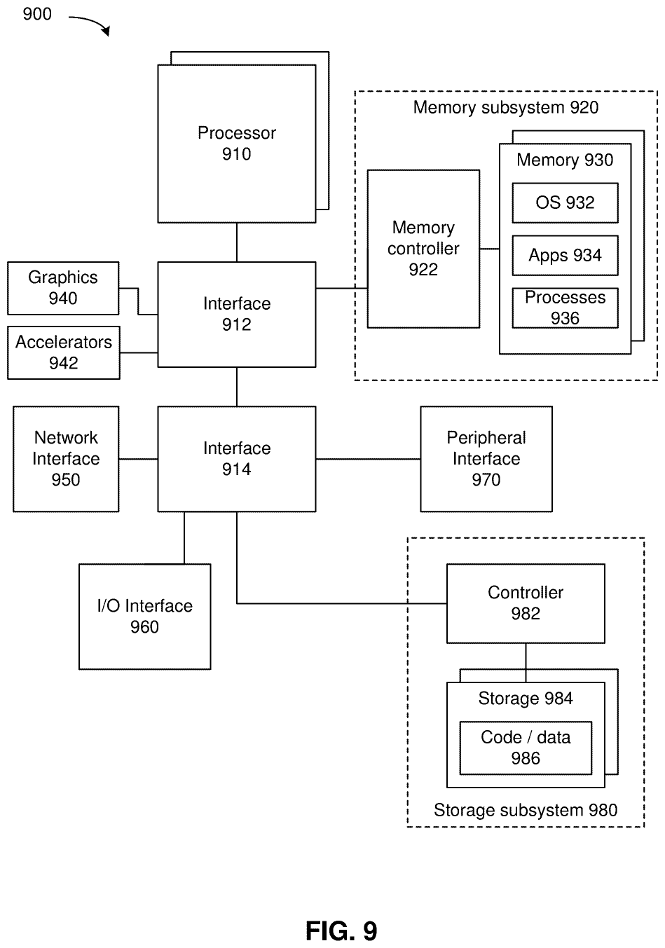

FIG. 9 depicts a system. In some examples, circuitry of network interface device can be utilized to perform header processing, bypass copying of the header payload to user space, and combine the processed header with the packet body, and/or update headers of a packet without providing the received packet for reliable data transmission protocol processing except for connection termination packet, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 932 or driver can advertise capability of network interface device 950 or other processor-executed processes to perform processing of HTTP headers in user space without copying HTTP payloads to user space and can form a packet with processed HTTP headers and HTTP payloads in kernel space and/or update headers of a packet without providing the received packet for reliable data transmission protocol processing except for connection termination packet. In some examples, OS 932 or driver can enable or disable use of network interface device 950 or other processor-executed processes to perform processing of HTTP headers in user space without copying HTTP payloads to user space and can form a packet with processed HTTP headers and HTTP payloads in kernel space and/or update headers of a packet without providing the received packet for reliable data transmission protocol processing except for connection termination packet.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, packet processing device or network interface device 950 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 8.

In one example, system 900 includes one or more input/output (I/O) interface(s) 960. I/O interface 960 can include one or more interface components through which a user interacts with system 900. Peripheral interface 970 can include any hardware interface not specifically mentioned above. Peripherals refer generally to devices that connect dependently to system 900.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 900 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium comprising instructions stored thereon, that if executed by one or more processors, cause the one or more processors to: based on receipt of a Hypertext Transfer Protocol (HTTP) packet at a network interface device, the HTTP packet comprising an HTTP body and HTTP header: provide the HTTP header, but not the HTTP body, for processing in user space; modify solely the HTTP header in user space; and in kernel space, combine the modified HTTP header and the HTTP body prior to transmission of the HTTP packet with modified HTTP header to a client.

Example 2 includes one or more examples, wherein the modify solely the HTTP header in user space comprises add or modify a field in the HTTP header.

Example 3 includes one or more examples, wherein an extended Berkeley Packet Filter (eBPF) provides the HTTP header, but not the HTTP body, for processing in user space.

Example 4 includes one or more examples, wherein the HTTP packet is encrypted and comprising instructions stored thereon, that if executed by the one or more processors, cause the one or more processors to: decrypt the encrypted HTTP packet prior to the provide the HTTP header, but not the HTTP body, for processing in user space.

Example 5 includes one or more examples, wherein the one or more processors are part of the network interface device.

Example 6 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

Example 7 includes one or more examples, and includes a method that includes: based on receipt of a Hypertext Transfer Protocol (HTTP) packet at a network interface device: in a first mode: update headers of the received packet without providing the received packet for data transmission protocol processing but based on the received packet comprising a connection termination packet, provide the received packet with connection termination packet for reliable data transmission protocol processing and in a second mode: provide the received packet for data transmission protocol processing.

Example 8 includes one or more examples, wherein the connection termination packet comprises Transmission Control Protocol (TCP) RESET packet or FINISH packet.

Example 9 includes one or more examples, and includes performing the first mode in the network interface device.

Example 10 includes one or more examples, wherein the data transmission protocol comprises one or more of: Transmission Control Protocol (TCP), remote direct memory access (RDMA), User Datagram Protocol (UDP), quick UDP Internet Connections (QUIC), RDMA over Converged Ethernet (RoCE), or RoCE v2.

Example 11 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

Example 12 includes one or more examples, and includes apparatus that includes a memory to store instructions and a processor, wherein execution of the instructions by the processor is to cause: based on receipt of a Hypertext Transfer Protocol (HTTP) packet at a network interface device, the HTTP packet comprising an HTTP body and HTTP header: provide the HTTP header, but not the HTTP body, for processing in user space; modify solely the HTTP header in user space; and in kernel space, combine the modified HTTP header and the HTTP body prior to transmission of the HTTP packet with modified HTTP header to a client.

Example 13 includes one or more examples, wherein the modify solely the HTTP header in user space comprises add or modify a field in the HTTP header.

Example 14 includes one or more examples, wherein an extended Berkeley Packet Filter (eBPF) provides the HTTP header, but not the HTTP body, for processing in user space.

Example 15 includes one or more examples, wherein the HTTP packet is encrypted and comprising instructions stored thereon, that if executed by the one or more processors, cause the one or more processors to decrypt the encrypted HTTP packet prior to the provide the HTTP header, but not the HTTP body, for processing in user space.

Example 16 includes one or more examples, wherein the one or more processors are part of the network interface device.

Example 17 includes one or more examples, wherein based on execution of the instructions, the processor is to: based on receipt of a Hypertext Transfer Protocol (HTTP) packet at a network interface device: in a first mode: update headers of the received packet without providing the received packet for reliable data transmission protocol processing but based on the received packet comprising a connection termination packet, provide the received packet with connection termination packet for reliable data transmission protocol processing and in a second mode: provide the received packet for reliable data transmission protocol processing.

Example 18 includes one or more examples, wherein the connection termination packet comprises Transmission Control Protocol (TCP) RESET packet or FINISH packet.

Example 19 includes one or more examples, wherein the reliable data transmission protocol comprises one or more of: Transmission Control Protocol (TCP), remote direct memory access (RDMA), quick User Datagram Protocol (UDP) Internet Connections (QUIC), RDMA over Converged Ethernet (RoCE), or RoCE v2.

Example 20 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

1. At least one non-transitory computer-readable medium comprising instructions stored thereon, that if executed by one or more processors, cause the one or more processors to:
based on receipt of a Hypertext Transfer Protocol (HTTP) packet at a network interface device, the HTTP packet comprising an HTTP body and HTTP header:
provide the HTTP header, but not the HTTP body, for processing in user space;
modify solely the HTTP header in user space; and
in kernel space, combine the modified HTTP header and the HTTP body prior to transmission of the HTTP packet with modified HTTP header to a client.

2. The at least one non-transitory computer-readable medium of claim 1, wherein the modify solely the HTTP header in user space comprises add or modify a field in the HTTP header.

3. The at least one non-transitory computer-readable medium of claim 1, wherein an extended Berkeley Packet Filter (eBPF) provides the HTTP header, but not the HTTP body, for processing in user space.

4. The at least one non-transitory computer-readable medium of claim 1, wherein the HTTP packet is encrypted and comprising instructions stored thereon, that if executed by the one or more processors, cause the one or more processors to:
decrypt the encrypted HTTP packet prior to the provide the HTTP header, but not the HTTP body, for processing in user space.

5. The at least one non-transitory computer-readable medium of claim 1, wherein the one or more processors are part of the network interface device.

6. The at least one non-transitory computer-readable medium of claim 1, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

7. A method comprising:
based on receipt of a Hypertext Transfer Protocol (HTTP) packet at a network interface device:
in a first mode: update headers of the received HTTP packet without providing the received packet for data transmission protocol processing but based on the received packet comprising a connection termination packet, provide the received packet with connection termination packet for reliable data transmission protocol processing and
in a second mode: provide the received packet for data transmission protocol processing.

8. The method of claim 7, wherein the connection termination packet comprises Transmission Control Protocol (TCP) RESET packet or FINISH packet.

9. The method of claim 7, comprising: performing the first mode in the network interface device.

10. The method of claim 7, wherein the data transmission protocol comprises one or more of: Transmission Control Protocol (TCP), remote direct memory access (RDMA), User Datagram Protocol (UDP), quick UDP Internet Connections (QUIC), RDMA over Converged Ethernet (ROCE), or RoCE v2.

11. The method of claim 7, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

12. An apparatus comprising:
a memory to store instructions and
a processor, wherein execution of the instructions by the processor is to cause:
based on receipt of a Hypertext Transfer Protocol (HTTP) packet at a network interface device, the HTTP packet comprising an HTTP body and HTTP header:
provide the HTTP header, but not the HTTP body, for processing in user space;
modify solely the HTTP header in user space; and
in kernel space, combine the modified HTTP header and the HTTP body prior to transmission of the HTTP packet with modified HTTP header to a client.

13. The apparatus of claim 12, wherein the modify solely the HTTP header in user space comprises add or modify a field in the HTTP header.

14. The apparatus of claim 12, wherein an extended Berkeley Packet Filter (eBPF) provides the HTTP header, but not the HTTP body, for processing in user space.

15. The apparatus of claim 12, wherein the HTTP packet is encrypted and comprising instructions stored thereon, that if executed by the one or more processors, cause the one or more processors to decrypt the encrypted HTTP packet prior to the provide the HTTP header, but not the HTTP body, for processing in user space.

16. The apparatus of claim 12, wherein the one or more processors are part of the network interface device.

17. The apparatus of claim 12, wherein based on execution of the instructions, the processor is to:
based on receipt of a Hypertext Transfer Protocol (HTTP) packet at a network interface device:
in a first mode: update headers of the received HTTP packet without providing the received packet for reliable data transmission protocol processing but based on the received packet comprising a connection termination packet, provide the received packet with connection termination packet for reliable data transmission protocol processing and
in a second mode: provide the received packet for reliable data transmission protocol processing.

18. The apparatus of claim 17, wherein the connection termination packet comprises Transmission Control Protocol (TCP) RESET packet or FINISH packet.

19. The apparatus of claim 17, wherein the reliable data transmission protocol comprises one or more of: Transmission Control Protocol (TCP), remote direct memory access (RDMA), quick User Datagram Protocol (UDP) Internet Connections (QUIC), RDMA over Converged Ethernet (ROCE), or RoCE v2.

20. The apparatus of claim 12, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).
